(19) United States
(12) Patent Application Publication
(10) Pub. No.: US 2008/0274883 A1
(43) Pub. Date: Nov. 6, 2008

(54) Fungicidal Mixtures

(75) Inventors: Markus Gewehr, Kastellaun (DE); Reinhard Stierl, Freinsheim (DE); Matthias Niedenbruck, Limburgerhof (DE); Udo Hunger, Mainz (DE)

Correspondence Address: BRINKS, HOFER, GILSON & LIONE, 2801 SLATER ROAD, SUITE 120, MORRISVILLE, NC, 27560, US

(73) Assignee: BASF AKTIENGESELLSCHAFT, Ludwigshafen (DE)

(21) Appl. No.: 11/793,796

(22) PCT Filed: Dec. 21, 2005
(86) PCT No.: PCT/EP05/13779

§ 371 Date: Jun. 21, 2007

(30) Foreign Application Priority Data
Dec. 23, 2004 (DE) 10 2004 063 308.8

(51) Int. Cl. A01N 43/84; A01N 25/00; A01P 3/00

(52) U.S. Cl. 504/100; 514/237.5

(57) ABSTRACT

Fungicidal mixtures comprising
1) enestroburin of formula I:

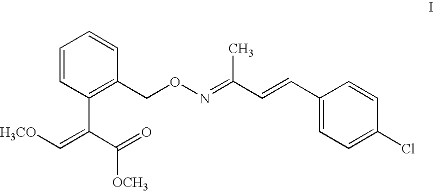

and
2) dimethomorph of formula II:

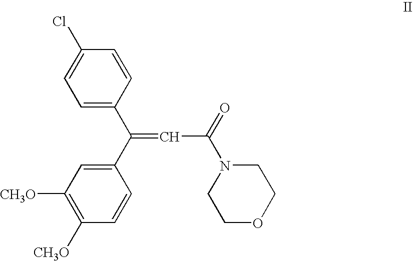

as active components in a synergistically effective amount, method of controlling harmful fungi using mixtures of compound I with compound II, use of compound I with compound II for the preparation of such mixtures, and compositions comprising these mixtures.

The present invention relates to fungicidal mixtures comprising

1) enestroburin of formula I:

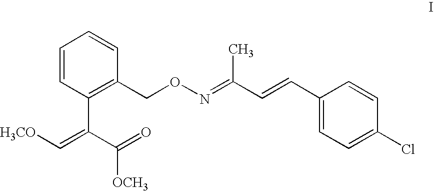

and
2) dimethomorph of formula II:

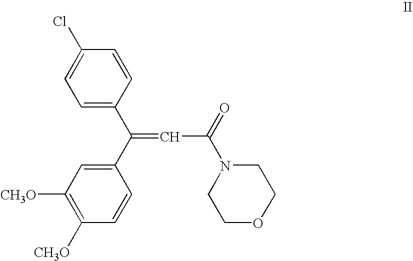

as active components in a synergistically effective amount.

The invention further relates to a method of controlling harmful fungi using mixtures of compound I with compound II, to the use of compound I with compound II for the preparation of such mixtures, and to compositions comprising these mixtures.

The strobilurin derivative of formula I described above as component 1, i.e. methyl 2-(2-[3-(4-chlorophenyl)-1-methyl-allylidenaminooxymethyl]phenyl)-3-methoxyacrylate, its preparation and its action against harmful fungi are known from the literature (EP-A 936 213, common name: enestroburin).

The compound of formula II, i.e. 3-(4-chlorophenyl)-3-(3,4-dimethoxyphenyl)-1-morpholin-4-ylpropenone, its preparation and its action against harmful fungi are likewise known from the literature (EP-A 120 321, common name: dimethomorph). The compound is in the form of a mixture of E,Z isomers.

In order to reduce the applied amounts and broaden the spectrum of action of the known compounds, the object of the present inventions was to provide mixtures that exhibit an improved action against harmful fungi, especially those of the class oomycetes, coupled with a reduced total amount of applied active substances.

Accordingly, the mixtures defined at the outset were found. It was also found that by using compound I and compound II simultaneously, either together or separately, or by using compound I and compound II successively, harmful fungi can be controlled better than with the individual compounds (synergistic mixtures). The simultaneous use of compound I with compound II, either together or separately, increases the fungicidal efficacy to a superadditive extent.

The mixtures of compound I and compound II, or the simultaneous use of compound I and compound II, either together or separately, are distinguished by an outstanding efficacy against a broad spectrum of phytopathogenic fungi, especially of the classes ascomycetes, deuteromycetes, oomycetes and basidiomycetes. They have a systemic effect in some cases and can be used in plant protection as leaf and soil fungicides.

They are particularly important for controlling a large number of fungi on various crop plants such as bananas, cotton, vegetable plants (e.g. cucumbers, beans and Cucurbitaceae), barley, grass, oats, coffee, potatoes, maize, fruit plants, rice, rye, soybean, tomatoes, vine, wheat, ornamental plants, sugar cane and a large number of seeds.

Advantageously, they are suitable for controlling the following phytopathogenic fungi: Blumeria graminis (true mildew) on cereals, Erysiphe cichoracearum and Sphaerotheca fuliginea on Cucurbitaceae, Podosphaera leucotricha on apples, Uncinula necator on vines, Puccinia species on cereals, Rhizoctonia species on cotton, rice and turf, Ustilago species on cereals and sugar cane, Venturia inaequalis on apples, Bipolaris and Drechslera species on cereals, rice and turf, Septoria species on wheat, Botrytis cinerea on strawberries, vegetables, ornamental plants and vines, Mycosphaerella species on bananas, groundnuts and cereals, Pseudocercosporella herpotrichoides on wheat and barley, Pyricularia oryzae on rice, Phytophthora infestans on potatoes and tomatoes, Pseudoperonospora species on Cucurbitaceae and hops, Plasmopara viticola on vines, Alternaria species on vegetables and fruit, and Fusarium and Verticillium species.

Mixtures of compound I and compound II are particularly suitable for controlling true and false mildew fungi (Erysiphales and oomycetes).

They can also be used to protect materials (e.g. wood), for example against Paecilomyces variotii.

Compound I and compound II can be applied simultaneously, either together or separately, or successively, the success of the control generally being unaffected by the order when they are applied separately.

It is conventional to use mixtures of compound I with compound II, but mixtures of compound I with two or, if appropriate, several active components may be advantageous under certain circumstances.

Fungicidal active substances from the following group are particularly suitable as other active components in the above sense:
acylalanines such as benalaxyl, metalaxyl, ofurace or oxadixyl,
amine derivatives such as aldimorph, dodine, dodemorph, fenpropimorph, fenpropidin, guazatine, iminoctadine, spiroxamin or tridemorph,
anilinopyrimidines such as pyrimethanil, mepanipyrim or cyprodinil,
antibiotics such as cycloheximide, griseofulvin, kasugamycin, natamycin, polyoxin or streptomycin,
azoles such as bitertanol, bromoconazole, cyproconazole, difenoconazole, dinitroconazole, enilconazole, epoxiconazole, fenbuconazole, fluquiconazole, flusilazole, flutriafol, hexaconazole, imazalil, ipconazole, metconazole, myclobutanil, penconazole, propiconazole, prochloraz, prothioconazole, simeconazole, tebuconazole, tetraconazole, triadimefon, triadimenol, triflumizole or triticonazole,
dicarboximides such as iprodione, myclozolin, procymidone or vinclozolin,
dithiocarbamates such as ferbam, nabam, maneb, mancozeb, metam, metiram, propineb, polycarbamate, thiram, ziram or zineb,
heterocyclic compounds such as anilazine, benomyl, boscalid, carbendazim, carboxin, oxycarboxin, cyazofamid, dazomet, dithianone, famoxadone, fenamidone, fenarimol, fuberidazole, flutolanil, furametpyr, isoprothiolan, mepronil, nuarimol, picobenzamid, probenazole, proquinazid, pyrifenox, pyroquilone, quinoxyfen, silthiofam, thiabendazole, thifluzamide, thiophanate-methyl, tiadinil, tricyclazole, triforine, 3-[5-(4-chlorophenyl)-2,3-dimethylisoxazolidin-3-yl]pyridine or 5-chloro-7-(4-methylpiperidin-1-yl)-6-(2,4,6-trifluorophenyl)-[1,2,4]triazolo[1,5-a]pyrimidine,
copper fungicides such as Bordeaux mixture, copper acetate, copper oxychloride or basic copper sulfate,
nitrophenyl derivatives such as binapacryl, dinocap, dinobuton or nitrophthalisopropyl,
phenylpyrroles such as fenpiclonil or fludioxonil,
sulfur,
other fungicides such as acibenzolar-5-methyl, benthiavalicarb, carpropamid, chlorothalonil, cyflufenamid, cymoxanil, diclomezin, diclocymet, diethofencarb, edifenphos, ethaboxam, fenhexamid, fentin acetate, fenoxanil, ferimzone, fluazinam, fosetyl, fosetyl-aluminum, phosphorous acid and its salts, iprovalicarb, hexachlorobenzene, metrafenone, pencycurone, propamocarb, phthalid, toloclofosmethyl, quintozene or zoxamid,
strobilurins such as azoxystrobin, dimoxystrobin, fluoxastrobin, kresoxim-methyl, metominostrobin, orysastrobin, picoxystrobin, pyraclostrobin or trifloxystrobin,
sulfenic acid derivatives such as captafol, captan, dichlofluanid, folpet or tolylfluanid.

Compound I and compound II are conventionally used in a weight ratio of 100:1 to 1:100, preferably of 20:1 to 1:20 and particularly preferably of 20:1 to 1:10.

If desired, the other active components are admixed to compound I in a ratio of 20:1 to 1:20.

The applied amounts of the mixtures according to the invention are 5 g/ha to 2000 g/ha, preferably 50 to 900 g/ha and particularly preferably 50 to 750 g/ha, depending on the type of compound and desired effect.

Correspondingly, the applied amounts of compound I are normally 1 to 1000 g/ha, preferably 10 to 900 g/ha and particularly preferably 20 to 750 g/ha.

Correspondingly, the applied amounts of compound II are normally 1 to 2000 g/ha, preferably 10 to 900 g/ha and particularly preferably 40 to 500 g/ha.

In the case of seed treatment, the applied amounts of mixture are generally 1 to 1000 g/100 kg of seed, preferably 1 to 750 g/100 kg and particularly preferably 5 to 500 g/100 kg.

The method of controlling harmful fungi comprises the application of compound I and compound II, either separately or together, or of mixtures of compound I and compound II, by spraying or dusting the seeds, the plants or the soil before or after the plants have been sown or before or after they have emerged.

The mixtures according to the invention, or compound I and compound II, can be converted to the conventional formulations, e.g. solutions, emulsions, suspensions, dusts, powders, pastes and granules. The application form is governed by the particular purpose; in every case it shall ensure a fine and uniform distribution of the compound according to the invention.

The formulations are prepared in known manner, e.g. by extending the active substance with solvents and/or carriers, if desired using emulsifiers and dispersants. The following are substantially suitable as solvents/auxiliary substances for this purpose:
water, aromatic solvents (e.g. Solvesso products, xylene), paraffins (e.g. petroleum fractions), alcohols (e.g. methanol, butanol, pentanol, benzyl alcohol), ketones (e.g. cyclohexanone, gamma-butyrolactone), pyrrolidones (NMP, NOP), acetates (glycol diacetate), glycols, fatty acid dimethylamides, fatty acids and fatty acid esters. Solvent mixtures can also be used in principle.
carriers such as natural crushed rocks (e.g. kaolins, aluminas, talcum, chalk) and synthetic crushed rocks (e.g. highly disperse silicic acid, silicates), emulsifiers such as non-ionic and anionic emulsifiers (e.g. polyoxyethylene fatty alcohol ethers, alkylsulfonates and arylsulfonates) and dispersants such as lignosulfite spent liquors and methyl cellulose.

Surface-active substances used are alkali metal, alkaline earth metal and ammonium salts of lignosulfonic acid, naphthalenesulfonic acid, phenolsulfonic acid and dibutylnaphthalenesulfonic acid, alkylarylsulfonates, alkylsulfates, alkylsulfonates, fatty alcohol sulfates, fatty acids and sulfated fatty alcohol glycol ethers, other suitable surfaceactive substances being condensation products of sulfonated naphthalene and naphthalene derivatives with formaldehyde, condensation products of naphthalene or naphthalenesulfonic acid with phenol and formaldehyde, polyoxyethylene octylphenol ethers, ethoxylated isooctylphenol, octylphenol, nonylphenol, alkylphenol polyglycol ethers, tributylphenyl polyglycol ethers, tristearylphenyl polyglycol ethers, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite spent liquors and methyl cellulose.

The following are suitable for the preparation of directly sprayable solutions, emulsions, pastes or oily dispersions: medium-boiling to high-boiling mineral oil fractions such as kerosene or diesel oil, as well as coal tar oils and oils of vegetable or animal-origin, aliphatic, cyclic and aromatic hydrocarbons, e.g. toluene, xylene, paraffin, tetrahydronaphthalene, alkylated naphthalenes or derivatives thereof, methanol, ethanol, propanol, butanol, cyclohexanol, cyclohexanone, isophorone, and strongly polar solvents, e.g. dimethyl sulfoxide, N-methylpyrrolidone or water.

Powders, tracking powders and dusts can be prepared by mixing the active substances, or grinding them together, with a solid carrier.

Granules, e.g. coated, impregnated and homogeneous granules, can be prepared by binding the active substances to solid carriers. Examples of solid carriers are mineral earths such as silica gels, silicates, talcum, kaolin, attaclay, limestone, lime, chalk, bole, loess, clay, dolomite, diatomaceous earth, calcium and magnesium sulfates and magnesium oxide, ground plastics, fertilizers such as ammonium sulfate, ammonium phosphate, ammonium nitrate and ureas, and vegetable products such as cereal flour, ground bark, wood flour and ground nutshells, cellulose powders and other solid carriers.

The formulations generally comprise between 0.01 and 95% by weight, preferably between 0.1 and 90% by weight, of active substances, the latter being used in a purity of 90% to 100%, preferably of 95% to 100% (according to NMR spectrum).

Examples of formulations are: 1. Products for dilution in water

A Water-soluble concentrates (SL, LS)

10 parts by weight of active substances are dissolved in 90 parts by weight of water or water-soluble solvent. Alternatively, wetting agents or other auxiliary substances are added. The active substance dissolves on solution in water to give a formulation with an active substance content of 10% by weight.

B Dispersible concentrates (DC)

20 parts by weight of active substances are dissolved in 70 parts by weight of cyclohexanone with the addition of 10 parts by weight of a dispersant, e.g. polyvinylpyrrolidone. A dispersion is obtained on dilution in water. The active substance content is 20% by weight.

C Emulsifiable concentrates (EC)

15 parts by weight of active substances are dissolved in 75 parts by weight of xylene with the addition of calcium dodecylbenzenesulfonate and castor oil ethoxylate (5 parts by weight in each case). An emulsion is obtained on dilution in water. The formulation has an active substance content of 15% by weight.

D Emulsions (EW, EO, ES)

25 parts by weight of active substances are dissolved in 35 parts by weight of xylene with the addition of calcium dodecylbenzenesulfonate and castor oil ethoxylate (5 parts by weight in each case). Using an emulsifying machine (e.g. Ultraturax), this mixture is added to 30 parts by weight of water and processed to a homogeneous emulsion. An emulsion is obtained on dilution in water. The formulation has an active substance content of 25% by weight.

E Suspensions (SC, OD, FS)

Using a stirred ball mill, 20 parts by weight of active substances are comminuted to a fine active substance suspension with the addition of 10 parts by weight of dispersants and wetting agents and 70 parts by weight of water or organic solvent. A stable suspension of active substance is obtained on dilution in water. The active substance content of the formulation is 20% by weight.

F Water-dispersible and water-soluble granules (WG, SG)

50 parts by weight of active substances are finely ground with the addition of 50 parts by weight of dispersants and wetting agents, and processed to water-dispersible or water-soluble granules by technical means (e.g. extrusion, spraying tower, fluidized bed). A stable dispersion or solution of the active substance is obtained on dilution in water. The formulation has an active substance content of 50% by weight.

G Water-dispersible and water-soluble powders (WP, SP, SS, WS)

75 parts by weight of active substances are ground in a rotor-stator mill with the addition of 25 parts by weight of dispersants and wetting agents and also silica gel. A stable dispersion or solution of the active substance is obtained on dilution in water. The active substance content of the formulation is 75% by weight.

H Gel formulations

20 parts by weight of active substances, 10 parts by weight of dispersant, 1 part by weight of gelling agent and 70 parts by weight of water or organic solvent are ground to a fine suspension in a ball mill. A stable suspension with an active substance content of 20% by weight is obtained on dilution in water.

### 2. Products for Direct Application

I Dusts (DP, DS)

5 parts by weight of active substances are finely ground and intimately mixed with 95 parts by weight of finely divided kaolin to give a dust with an active substance content of 5% by weight.

J Granules (GR, FG, GG, MG)

0.5 part by weight of active substances is finely ground and combined with 99.5 parts by weight of carriers. Extrusion, spray drying and fluidized bed are common processes used to obtain granules for direct application which have an active substance content of 0.5% by weight.

K ULV solutions (UL)

10 parts by weight of active substances are dissolved in 90 parts by weight of organic solvent, e.g. xylene, to give a product for direct application which has an active sub-stance content of 10% by weight.

Seed treatment is conventionally effected using water-soluble concentrates (LS), suspensions (FS), dusts (DS), water-dispersible and water-soluble powders (WS, SS), emulsions (ES), emulsifiable concentrates (EC) and gel formulations (GF). These formulations can be applied to the seed undiluted or, preferably, diluted, and they can be applied before sowing.

It is preferable to use FS formulations for seed treatment. Conventionally, such formulations comprise 1 to 800 g/l of active substance, 1 to 200 g/l of surfactants, 0 to 200 g/l of antifreeze agents, 0 to 400 g/l of binders, 0 to 200 g/l of colorants, and solvents, preferably water.

The active substances can be used as such, in the form of their formulations or the application forms prepared therefrom, e.g. in the form of directly sprayable solutions, powders, suspensions or dispersions, emulsions, oily dispersions, pastes, dusts, tracking powders or granules, by spraying, nebulization, dusting, sprinkling or watering. The application forms are wholly governed by the purpose; in every case they should ensure the finest possible distribution of the active substances according to the invention.

Aqueous application forms can be prepared from emulsifiable concentrates, pastes or wettable powders (wettable powders, oily dispersions) by the addition of water. To pre-pare emulsions, pastes or oily dispersions, the substances, as such or dissolved in an oil or solvent, can be homogenized in water by means of wetting agents, tackifiers, dispersants or emulsifiers. However, it is also possible to prepare concentrates consisting of active substance, wetting agent, tackifier, dispersant or emulsifier and optionally solvent or oil, said concentrates being suitable for dilution with water.

The active substance concentrations of the ready-to-use formulations can be varied within wide limits. They are generally between 0.0001 and 10%, preferably between 0.01 and 1%.

The active substances can also be used successfully by the ultra-low-volume (ULV) method, it being possible to apply formulations with an active substance content of more than 95% by weight, or even the active substance without additives.

Oils of different types, wetting agents, adjuvants, herbicides, fungicides, other pest control agents and bactericides can be added to the active substances, if appropriate just before application (tank-mix method). These agents can be admixed to the compositions according to the invention in a weight ratio of 1:100 to 100:1, preferably of 1:10 to 10:1.

The following are particularly suitable as adjuvants in this sense: organically modified polysiloxanes, e.g. Break Thru S 240®; alcohol alkoxylates, e.g. Atplus 245®, Atplus MBA 1303®, Plurafac LF 300® and Lutensol ON 30®; EO-PO block polymers, e.g. Pluronic RPE 2035® and Genapol B®; alcohol ethoxylates, e.g. Lutensol XP 80®; and sodium dioctylsulfosuccinate, e.g. Leophen RA®.

The compounds I and II, or the mixtures or corresponding formulations, are applied by treating the harmful fungi, or the plants, seeds, soil, surfaces, materials or spaces to be kept free of said fungi, with a fungicidally effective amount of the mixture or of compounds I and II applied separately. They can be applied before or after infestation by the harmful fungi.

The fungicidal action of the compound and mixtures can be demonstrated by the following experiments:

The active substances were prepared, either separately or together, as a stock solution containing 25 mg of active substance, which was made up to 10 ml with a mixture of acetone and/or DMSO and the emulsifier Uniperol® EL (wetting agent with an emulsifying and dispersing effect based on ethoxylated alkylphenols) in a solvent/emulsifier volume ratio of 99 to 1. The volume was then made up to 100 ml with water. The solvent/emulsifier/water mixture described was used to dilute this stock solution to the active substance concentration indicated below.

### APPLICATION EXAMPLE 1

### Activity Against Tomato Leaf Mold Caused by Phytophthora infestans (Protective Treatment)

Leaves of potted tomato plants were sprayed until dripping wet with an aqueous suspension having the active substance concentration indicated below. The leaves were infested the next day with an aqueous slurry of Phytophthora infestans sporangia. The plants were then placed in a water vapor-saturated chamber at temperatures of between 18 and 20° C.

After 6 days the leaf mold had developed so extensively on the untreated but infested control plants that the infestation could be determined visually in %.

The visually determined values for the percentage of infested leaf surfaces were converted to efficiencies as % of the untreated control:

The efficiency (E) is calculated as follows according to Abbot's formula:

E=(1−α/β)·100

α corresponds to the fungal infestation of the treated plants in % and
β corresponds to the fungal infestation of the untreated (control) plants in %

When the efficiency is 0, the infestation of the treated plants corresponds to that of the untreated control plants; when the efficiency is 100, the treated plants exhibit no infestation.

The expected efficiencies for active substance combinations were determined according to Colby's formula (Colby, S. R. “Calculating synergistic and antagonistic responses of herbicide combinations”, Weeds, 15, pp 20-22, 1967) and compared with the observed efficiencies.

Colby's formula:

E=x+y−x·y/100
E expected efficiency, expressed in % of the untreated control, when using the mixture of active substances A and B in the concentrations a and b
x efficiency, expressed in % of the untreated control, when using active substance A in the concentration a
y efficiency, expressed in % of the untreated control, when using active substance B in the concentration b

| | | | | | Calculated |
|---|---|---|---|---|---|
| | | | | | action |
| | Active | Conc. | | Observed | acc. to |
| No. | substance | [ppm] | Ratio | action (%) | Colby (%) |
| 1 | — (control) | — | | 0 (90% infestation) | |
| 2 | enestrobin (I) | 1 | | 0 | |
| 3 | dimethomorph | 1 | | 22 | |
| | (II) | | | | |
| 4 | I + II | 1 + 1 | 1:1 | 44 | 22 |

### APPLICATION EXAMPLE 2

### Efficacy Against Wheat Mildew Caused by Erysiphe [syn. Blumeria] graminis Form a Specialis. tritici

The comparative active substance used was the compound 4-[3-(3,4-dimethoxyphenyl)-3-(4-fluorophenyl)-1-oxo-2-propenyl]morpholine (common name: flumorph), known from EP-A 860 438.

Leaves of pot-grown wheat seedlings were sprayed until dripping wet with an aqueous suspension having the active substance concentration indicated below. The suspension or emulsion was prepared as described above. 24 hours after the spray coating had dried, . . . dusted with spores of wheat mildew (Erysiphe [syn. Blumeria] graminis form a specialis. tritici). The experimental plants were then placed in a greenhouse at temperatures of between 20 and 24° C. and 60 to 90% relative humidity. After 7 days the extent of mildew development was determined visually in % infestation of the total leaf surface.

| | | | | | Calculated |
|---|---|---|---|---|---|
| | | | | | action |
| | Active | Conc. | | Observed | acc. to |
| No. | substance | [ppm] | Ratio | action (%) | Colby (%) |
| 5 | — (control) | — | | 0 (90% infestation) | |
| 6 | enestrobin (I) | 16 | | 33 | |
| 7 | dimethomorph | 4 | | 0 | |
| | (II) | | | | |
| 8 | flumorph | 4 | | 0 | |
| | (IIA) | | | | |
| 9 | I + II | 16 + 4 | 4:1 | 67 | 33 |
| 10 | I + IIA | 16 + 4 | 4:1 | 44 | 33 |

The experimental results show that, due to synergism, the mixtures according to the invention are appreciably more effective than previously calculated according to Colby's formula.

1-10. (canceled)

11. A fungicidal mixture for controlling phytopathogenic harmful fungi, the fungicidal mixture comprising two active components:
1) an enestroburin of formula I: 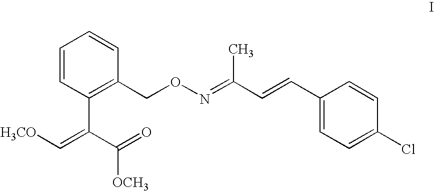
and
2) a dimethomorph of formula II: 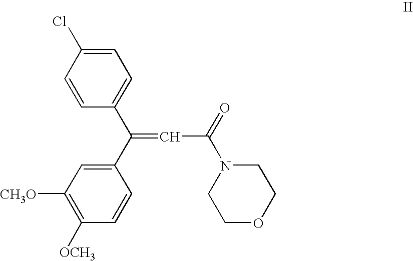
in a synergistically effective amount.

12. The fungicidal mixture according to claim 11, comprising enestroburin of formula I and dimethomorph of formula II in a weight ratio of 100:1 to 1:100.

13. A composition comprising a liquid or solid carrier and a mixture comprising:
an enestroburin of formula I: 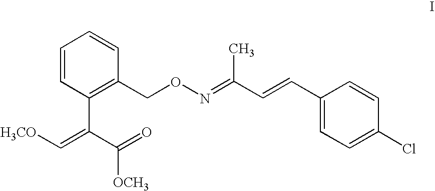
and
a dimethomorph of formula II:

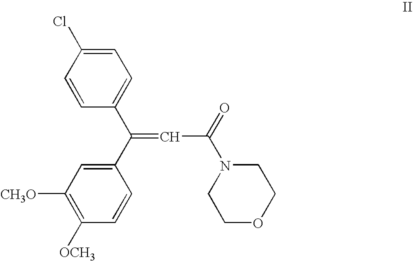

14. The composition according to claim 13, comprising enestroburin of formula I and dimethomorph of formula II in a weight ratio of 100:1 to 1:100.

15. A method of controlling phytopathogenic harmful fungi, the method comprising:
treating the phytopathogenic harmful fungi or a habitat, a plant, soil, or seed to be protected from fungal infestation with an effective amount of compounds of:
an enestroburin of formula I: 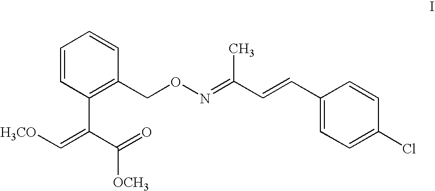
and
a dimethomorph of formula II:

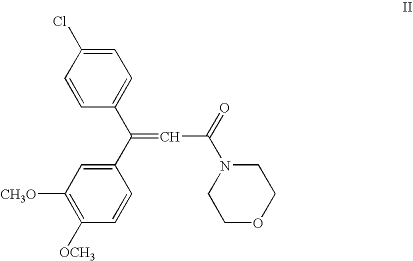

16. The method according to claim 15, wherein the compounds of formula I and II are applied simultaneously together, separately, or successively.

17. The method according to claim 15, wherein the compounds of formulae I and II are in a weight ratio of 100:1 to 1:100.

18. The method according to claim 15, wherein the compounds of formulae I and II are applied in an amount of 5 g/ha to 1000 g/ha.

19. The method according to claim 15, wherein true mildew fungi (Erysiphales) are controlled.

20. The method according to claim 15, wherein the compounds of formula I and II are applied in an amount of 1 to 10 g/100 kg of seed.

21. The method according to claim 20, wherein the compounds of formula I and II are in a weight ratio of 100:1 to 1:100.

22. Seed comprising a mixture of:
an enestroburin of formula I: 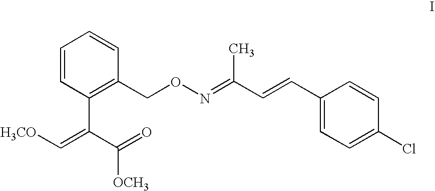
and
a dimethomorph of formula II: 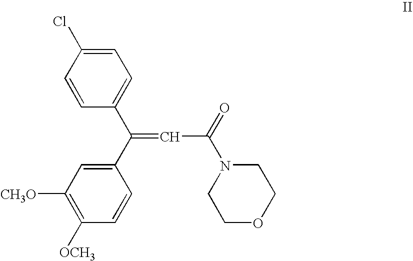
in an amount of 1 to 1000 g/100 kg of seed.
